(19) United States
(12) Patent Application Publication
(10) Pub. No.: US 2013/0067227 A1
(43) Pub. Date: Mar. 14, 2013

(54) System and Method for Anonymous Digital Communication

(71) Applicant: John Derrick, Los Altos, CA (US)

(72) Inventor: John Derrick, Los Altos, CA (US)

(21) Appl. No.: 13/410,166

(22) Filed: Mar. 1, 2012

Related U.S. Application Data
(60) Provisional application No. 61/447,786, filed on Mar. 1, 2011.

(51) Int. Cl. H04L 9/28

(52) U.S. Cl. 713/168

(57) ABSTRACT

A system and method for anonymous email, text messaging and social network communication between an initiator and one or more recipients. The system includes conversation tool which presents a menu page in which the initiator's telephone number, email address, social network identifier is submitted along with the recipient's telephone number, email address, or social network identifier, and a text message. The system includes a conversation server coupled to the communication network that receives the information from the menu page and forwards the text message to the desired number, address or identity. The conversation server includes an encryption/decryption engine that combines the initiator's number, address or network identity with the timestamp and then encrypts and embeds it into the text message. The reply containing the encrypted information is decrypted and routed by the conversation server. The communication tool hides the identities of the recipients from the initiator and the other recipients.

### CROSS-REFERENCE TO RELATED APPLICATION

This application claims the benefit of U.S. Provisional Patent Application Ser. No. 61/447,786, filed Mar. 1, 2011.

### COPYRIGHT NOTICE

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

The present invention generally relates to digital communications between two or more parties, and more particularly to digital communications between two or more parties wherein the identities of all or some of the parties are undisclosed.

2. Description of the Related Art

For many decades, editors have used a system in which proposed papers are submitted from authors for possible publication in their scientific journals. Rooted in the process is peer review process in which copies of the author's paper are sent to three or more expert scientists in the field. The paper is read carefully and each scientist prepares a ‘review’ of the paper. The editor then reads the reviews and determines whether the paper should be published in the journal.

The reviews often contain suggestions or comments that the scientists believe will improve the research discussed in the paper. Because the reviews can be harsh and critical and because the review of one scientist can influence the review of another scientist, the identity of each scientist is not disclosed to the author or to the other scientists.

Today, when two or more parties are communicating via email, text messaging or a social network website, all or some of the parties may desire to remain undisclosed or anonymous. In some instances, the initiator of the communication may desire to be anonymous when communicating with a known recipient. In other instances, the initiator may desire to communicate with a plurality of known recipients who are asked to reply anonymously so that the reply cannot be attributed to a particular recipient. In some instances when multiple recipients have received a message from an initiator, it may be desirable for the recipients to know the recipients who received a message. In some instances, it may be desirable for the recipients to know that the number of recipients that received a message. In some instances, it may be desirable for the recipients to know the domains of the recipients who received a message. In still other instances, it may be desirable to share some or all of the replies from the recipients with some or all of the other recipients.

Unfortunately, with digital communications between cellular telephones and between computers involve the transmission of unique telephone numbers, unique IP address, or unique social network identities over a communication network at a specific time, thereby enabling the identity and location of each party in a communication link to be easily determined. Generally, intermediate network components, such as switches, servers or hubs, could be setup to hide these parties' numbers and identities, using databases or look up tables.

Unfortunately, the use of databases and look-up tables create the following three significant problems:

First, for conversations between a plurality of parties, large data bases and backup processes are required.

Second, since each message or reply in the conversation requires a mapping steps between the real identity and the alternative one, additional indexing and searching steps must be performed that require more hardware and software resources.

Third, use of a database containing the identities and alternative identities records creates a security risk and additional steps must be taken to prevent security violations. For example, if the encryption process is compromised for one conversation, the security for all parties stored in the database may be compromised.

The invention described herein provides a simple why for parties to communicate anonymously without the use of large databases, lookup tables, or risk of security breach.

### SUMMARY OF THE INVENTION

A system and method disclosed herein is that enables parties in digital communication link to exchange text messages, email messages, and social networking messages anonymously. In the system and method the identities of the parties in a communication are mapped with alternative ones using encryption/decryption technology using the timestamp of the submission of the original message as an index into the security function that creates a unique encryption key. Accompanying the original message is additional information, called a command code that informs the conversation server if parties are to be anonymous or revealed and how reply messages are to be handled. Each reply message is routed through a server configured to instantly decrypt and interpret the encrypted and unencrypted data, thereby eliminating the use of a cross-linking database or lookup table. Because a unique encryption key is created in each conversation and then used throughout the conversation, the risk of a security compromise is reduced.

In addition to the reduced security, another key feature of the system and method disclosed herein is that the originator of the conversation (hereinafter called the initiator), first determines whether his or her identity will be disclosed to the recipient. Another key feature is that when a communication link is made between the initiator and a plurality of recipients whose identity may or may not be known to the initiator, the initiator may selectively adjust the system so that identities of the recipients who send reply messages are revealed, partially reviewed or anonymous to the initiator. A further key feature is that in a communication between an initiator and a plurality of recipients, the initiator can also selectively adjust the system so that individual identities of the recipients who submit reply messages are fully or partially disclosed to the other recipients or are anonymous to the other recipients.

The system includes software based conversation tool which presents a menu page on the initiator's computer or mobile communication device configured to connect to a digital communication network. The communication tool also acts as an embedded client that enables the computer or communication device to communicate with a host software program on the system's conversation server discussed further below. In one embodiment, the conversation tool presents a menu page on the computer's or communication device's display in which the system's telephone number or email address may be inputted to connect to the conversation server. In one embodiment, the system may require the initiator to initially sign into the system using a user account and password. The menu page may be web based program located system's website. In each scenario, the menu page also includes empty or blank lines or windows in which at least one recipient's telephone number, email address, or social network address is inputted. An empty text box is also provided on the menu page in which a text message or email message (hereinafter called a message) is manually inputted.

The initiator's computer or communication device is connected directly to a wired or wireless communication network. The wired or wireless communication network may be connected directly to the conversation server or to a second wired or wireless communication connected to the conversation server. In either scenario, a communication link is created between the initiator's computer or communication device and the conversation server.

The conversation server may include host software that enables it to communicate with initiator's communication device and receive downloaded information from the menu page. The conversation server is also configured to communicate with the recipient's telephone communication network or its data communication network that provides text messaging, email messaging or social network connectivity.

During use, the information from the menu page is transmitted to the conversation server and a timestamp is created. Linked to or loaded into the conservation server is an encryption/decryption engine that encrypts the initiator's telephone number, email address or social network identifier code and the timestamp, (called encrypted data). The encrypted data is then combined with the message. As discussed further below, when more than one recipient is listed in the menu page, group recipient information inputted on the menu page is also encrypted or partially encrypted and embedded into the message. When the encryption process is completed, the conservation server then forwards the message and encrypted data to the recipient's telephone number, email address or social network identity listed in the menu page.

When the recipient sends a reply message, a copy of the initiator's entire message and encrypted data or just the encrypted data is embedded in the reply message and sent to the conversation server. The encryption/decryption engine on the conversation server decrypts the encrypted data and routes the reply message to the initiator.

As stated above, on the menu page, two or more recipients may be listed thereby triggering a one to group communication session. When two or more recipients are listed, the group related data field on the menu page become active and are later encrypted by the encryption/decryption engine and combined with the initiator's encrypted data and embedded into the message and the reply message. The group data fields instruct the conversation server to either: (1) forward the reply message to all of the recipients submitted in the menu page’ (2) keep the recipient's information anonymous from the other recipients, reveal only the email domains (applicable only for email addresses), or (3) reveal the names of the other recipients in the reply message.

### BRIEF DESCRIPTION OF THE DRAWINGS

FIG. 1 is an illustration of the overall anonymous communication system used between an initiator and one recipient, between an initiator and a single recipient and a plurality of recipients.

FIG. 2 is an illustration of a wireless telephone with a display and showing the menu page created by the conversation tool presented on the display.

FIG. 3 is an illustration of a communication between an initiator and a single recipient in which the initiator sends the completed menu page to the conversation server which then encrypts initiator's info with the message and then transmits it to the recipient who then sends a reply message with the initiator's encrypted data.

FIG. 4 is an illustration of a communication between an initiator and a plurality of recipients in which the initiator sends the completed menu page to the conversation server which then encrypts the initiator's info into the message that is then delivered to a plurality of recipients and showing a reply message from one recipient being delivered to the conversation server and not delivered to the other recipients.

FIG. 5 is an illustration of a communication between an initiator and a plurality of recipients similar to the illustration shown in FIG. 4 in which the initiator sends the completed menu page to the conversation server which then encrypts the initiator's info and embeds it into the message and showing a reply message from one recipient being delivered to the conversation server and routed to the initiator and to the other recipients.

FIG. 6 is an illustration showing the Menu page information being sent to the Conservation Server it is combined with the Timestamp and encrypted with the Encryption/Decryption engine to form a combination encrypted data file and unencrypted data file that is then sent to the recipient, the recipient, if desired, then transmits an encrypted and unencrypted data file containing the original encrypted data and the unencrypted data and the reply text message.

### DETAILED DESCRIPTION OF THE PREFERRED EMBODIMENT(S)

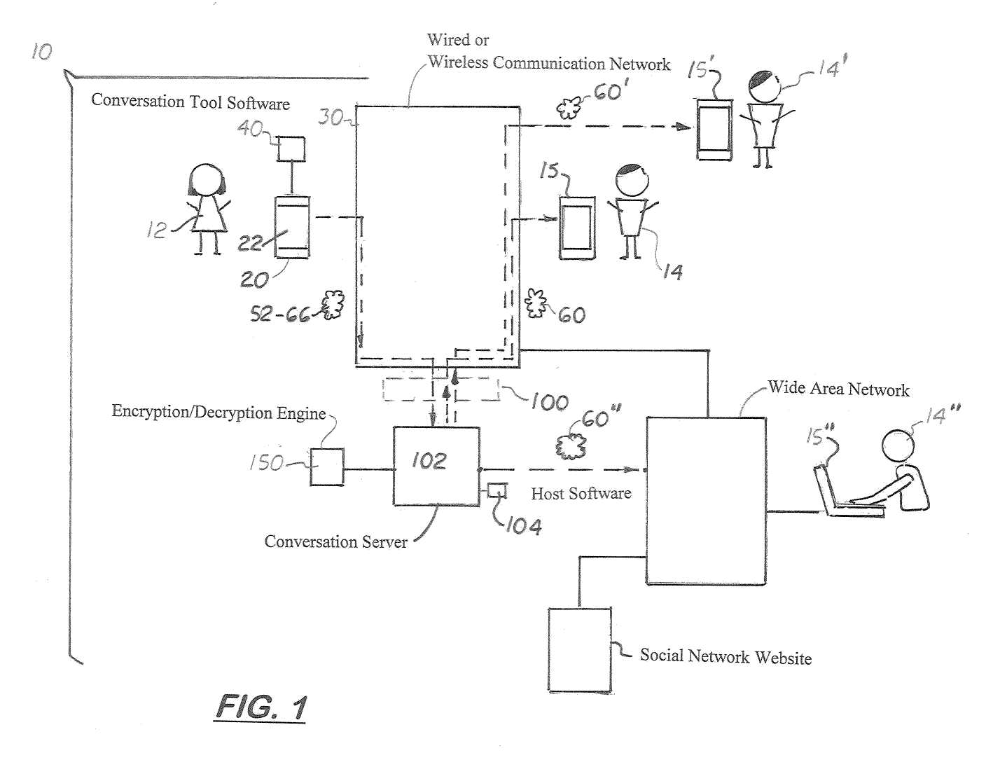

Referring to the accompanying FIG. 1, there is shown a system 10 for communicating text messages, email messages, and social network messages between an initiator 12 and one or more recipients 14, 14′, 14″. The system 10 is designed to allow the true identity of the initiator 12 to be hidden to one recipient 14 involved in two party communication link, or hidden in a communication link between the initiator 12 and a plurality of recipients 14, 14′, 14″.

The system 10 includes the use of an initiator's computer or communication device 20 is connected directly to wired or wireless communication network 30. The wired or wireless communication network 30 may be connected directly to the conversation server 102 or to a second wired or wireless communication network 100 connected to the conversation server 102. In either scenario, a communication link is created between the initiator's computer or communication device 20 and the conversation server 102

The system 10 includes conversation tool 40 which presents a menu page 50 in which the sender's telephone number, email address, and social network identity (generally indicated by the reference number 52), one or more recipients telephone numbers or email addresses (generally indicated by the reference number 54), subject line (generally indicated by reference number 56), text box (generally indicated by reference number 58). As discussed further below, also presented on the menu page 50 is a Send for Group Discussion YES and NO option lines (generally indicated by reference number 60), Fully Anonymous line (generally indicated by reference number 62), Reveal Domains of participants line (generally indicated by reference number 64), and Reveal Participants in Text Message line (generally indicated by reference number 66).

During use, the conversation server 102 includes host software 104 that enables it to communicate with the initiator's device 20 and receive information 52-66 from the initiator's menu page 50. After receiving the information 52-66 from the menu page 50 it then forwards the message 58 to the recipient's telephone number, email address, or social network address 54 submitted therewith. The conversation server 102 includes an encryption/decryption engine 150 that encrypts the initiator's number, address or network identity inputted on line 52 into the message 60 to create a message with the sender's encrypted identification code embedded therein (generally indicated by reference number 60′). The encrypted message 60′ is then displayed on the recipients 14, 14′, 14″ computer or communication devices 15, 15′, 15″, respectively.

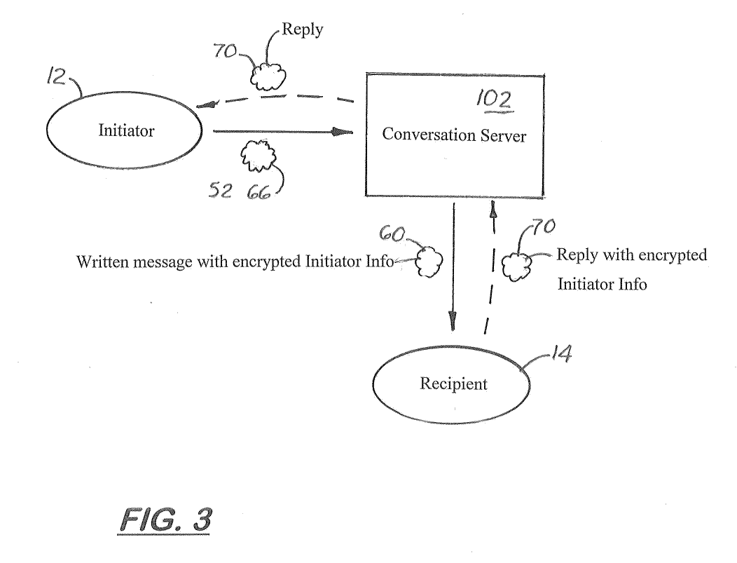

FIG. 3 is an illustration of a communication between an initiator 12 and a single recipient 14 in which the initiator 12 sends the completed menu page 50 to the conversation server 120 which then encrypts initiator's info 52 with the message 58 and then transmits the encrypted message 60 to the recipient 14 who then sends a reply 70 to conversation server 102 which then forwards the reply 70 to the initiator 14. When the recipient 14 sends a reply 70, the conversation server 102 decrypts the embedded initiator's encrypted information and routes the reply 70 to the initiator's computer or communication device 20.

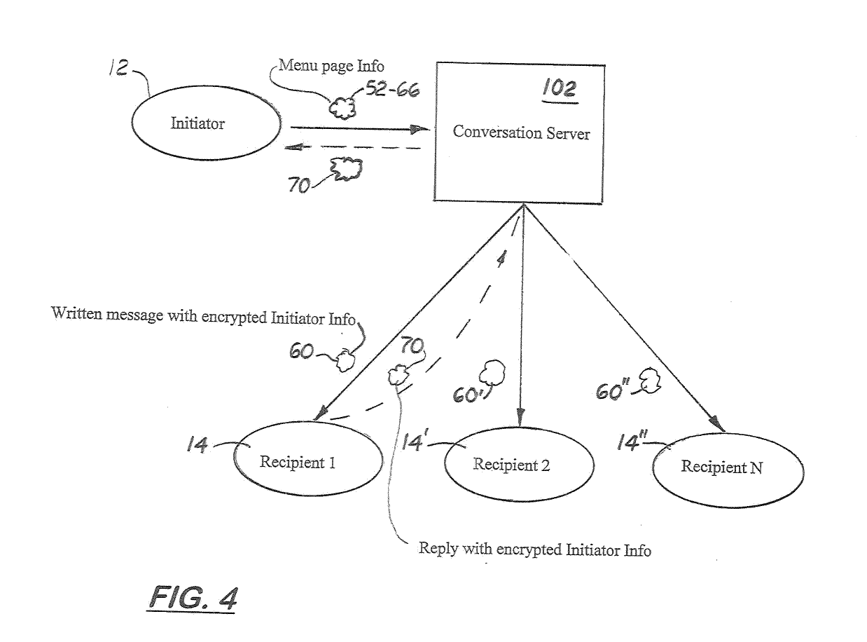

FIG. 4 is an illustration of a communication between an initiator 12 and a plurality of recipients, 14, 14′, 14″ in which the initiator 12 sends the menu information 52-56 to the conversation server 102 which then encrypts the initiator's identification information 52 and embeds it into three messages 60, 60′, 60″, respectively, which are then delivered to the three recipients 14, 14′, 14″. FIG. 4 also shows a reply 70 from the first recipient 14 being sent to the conversation server 102 which is then routed to the initiator 12.

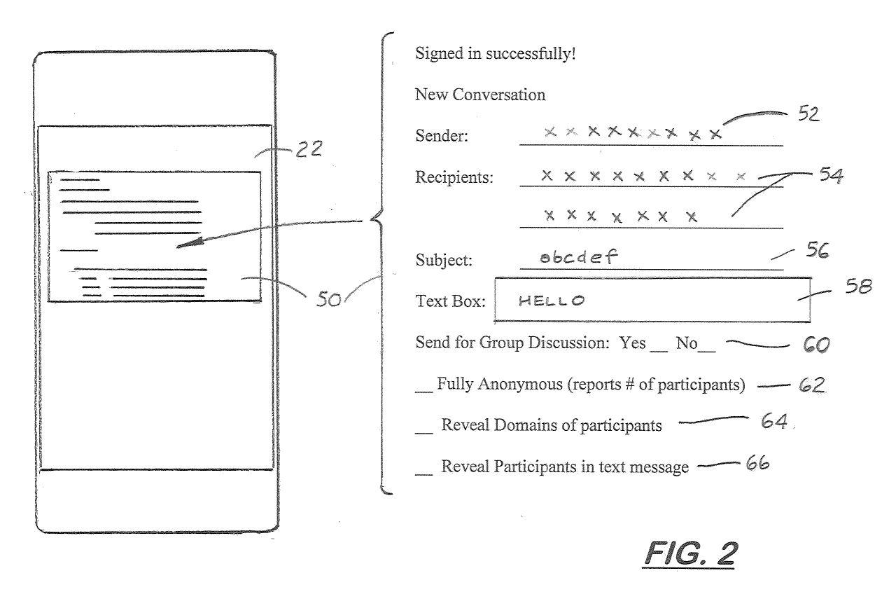

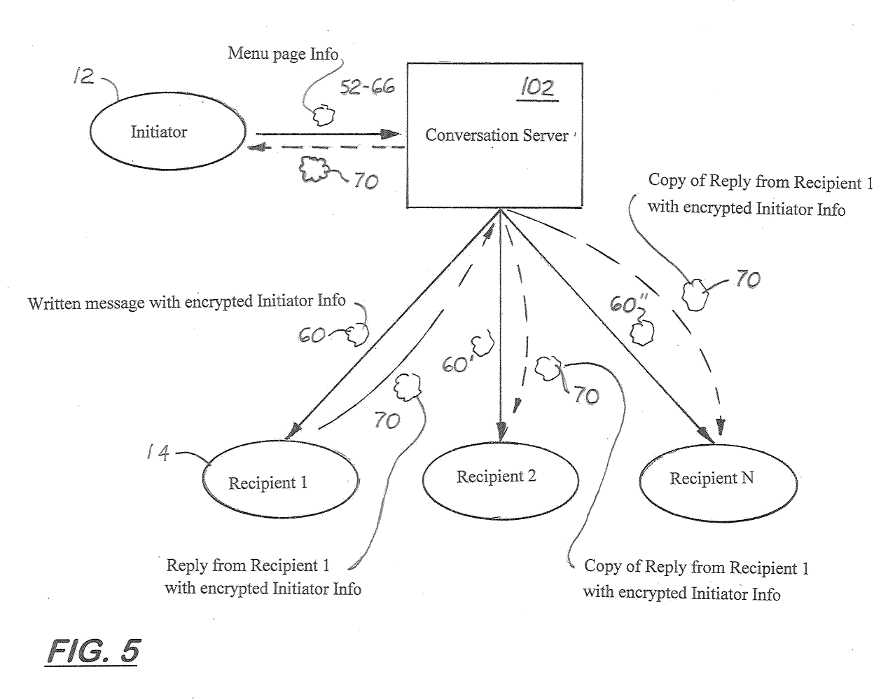

FIG. 5 is an illustration of a communication between an initiator 12 and a plurality of recipients 14, 14′, 14″ similar to the illustration shown in FIG. 4 in which the initiator 12 sends the completed menu information 52-56 to the conversation server 120 which then encrypts the initiator's identification information 52 embeds it into three messages 60, 60′, 60″ and delivered to the three recipients 14, 14′, 14″. In this illustration, the reply 70 from the first recipient 14 is sent to the conversation server 102 which is then routed to the initiator 12 and to the two other recipients 14′, 14″. Control of whether or not the reply 70 from one recipient 14 to the other recipients 14, 14″ is determined by the Send For Group Discussion option line 60 shown on the menu page 50 in FIG. 2.

As discussed previously, the initiator determines if the identities of the initiator and the recipients will be anonymous. On the menu page, the initiator marks his or her selection on the Fully Anonymous line (reference number 62 in FIG. 2). In the preferred embodiment, of the system, the total number of initiator and recipients is provided.

Also shown on FIG. 2, is a ‘Reveal Domains of Participants’ line generally indicated by reference number 64, in which the initiator selects whether the domain level of initiator's and recipient's email address will be revealed or disclosed to all of the recipients.

Also shown in FIG. 2 is a ‘Reveal Participants in text message’ line generally indicated by reference number 66, in which the initiator indicates if the email address of the recipients will be revealed to the other recipients.

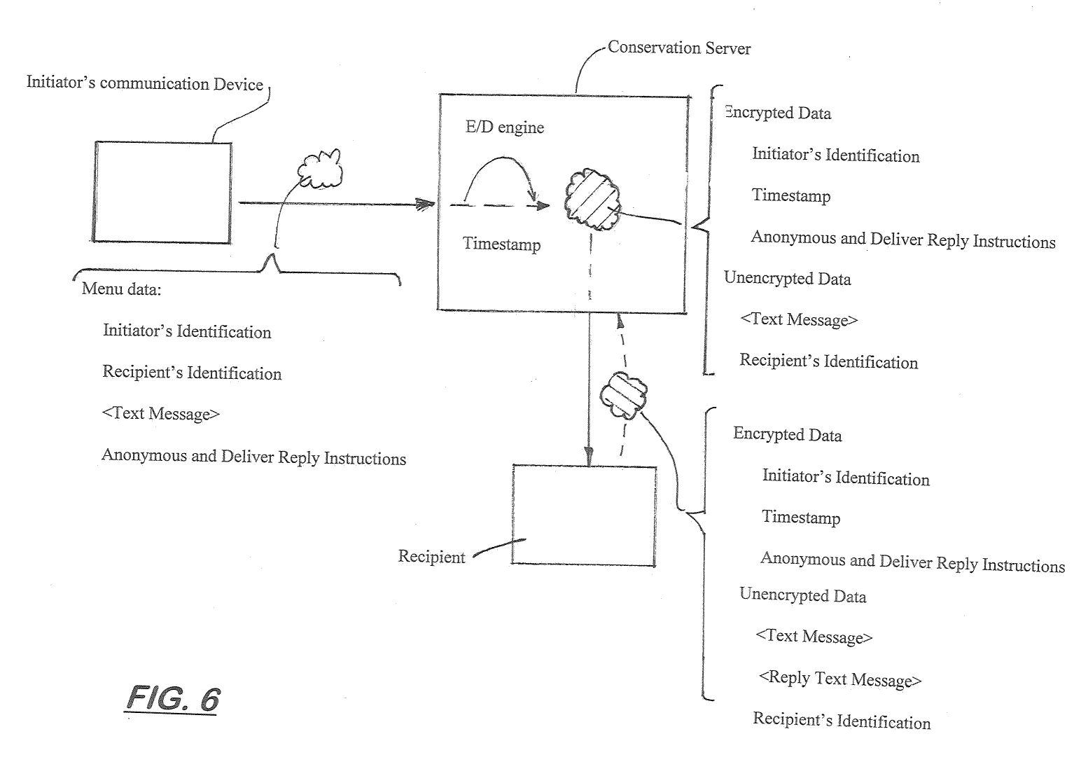

FIG. 6 is an illustration showing the Menu page information being sent to the Conservation Server it is combined with the Timestamp and encrypted with the Encryption/Decryption engine to form a combination encrypted and unencrypted file that is then sent to the recipient, the recipient, if desired, then transmits an encrypted and unencrypted file containing the original encrypted data and the unencrypted data and the reply text message.

Using the above described system 10, a method of communication over a digital communication network in which either the initiator of the communication or at least one recipient of the communication is anonymous comprising the following steps:

a. connecting a conversation server to said digital communication network configured to receive text messages and transmit text messages between an initiator and a recipient, said conversation server configured to encrypt the initiator's network identification and insert the initiator's encrypted network identification into said text message and forward text message and said initiator's encrypted network identification to a designed recipient, said conversation server also configured to receive a reply from said recipient containing the encrypted initiator's network identity, said conversation server decrypts said initiator's network identity and routes said reply message to said initiator;

b. initiating a digital network communication by an initiator with at least one designated recipient, said initiator and said recipient each being assigned a unique network identification

c. creating a text message;

d. transmitting said text message, said initiator identification, and said recipient's network identification to said conversation server;

e. encrypting said initiator's network identification and a timestamp into said text message;

f. transmitting said text message and encrypted initiator's network identification and timestamp to said recipient; and,

g. receiving a reply containing said encrypted initiator's network identification and timestamp from said recipient and decrypting said initiator's network identification and said timestamp and routing said reply message to said initiator.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A system for anonymous communication over a digital communication network configured to telephone, text messaging, email messaging or in a social network service between an initiator and at least one recipient, said system comprising:
a. a communication device configured to connect to said communication network, said device includes a display means and working memory;
b. an initiator's identification code, said identification codes being compatible with a telephone communication, text messaging communication, email communication, and a social network communication;
c. a software conversation tool loaded into said working memory of said communication device, when said software conversation tool is operated, a menu page is presented on said display containing at least one recipient line upon which a desired telephone number, email address or social network identity of said recipient is inputted, and a text message box in which a text message for said recipient is inputted; and,
d. a conversation server coupled to said communication network and configured to receive the information inputted into said menu page on said communication device, said conversation server configured to encrypt said initiator's identification code and transmit said encrypted identification code and said text message to said recipient indicated on said recipient line of said menu page, said conversation server also configured receive a reply message from said recipient containing said encrypted identification code of said initiator and deliver said reply message to said initiator.

2. The system as recited in claim 1, further including an encryption/decryption engine located on or connected to say conversation server and configured to encrypt the initiator's identification code into said encrypted key.

3. The system as recited in claim 1, wherein said initiator's text message is time stamped and said encryption/decryption engine encrypts said timestamp and said initiator's identification code into an encrypted key which is embedded into said text message.

4. The system as recited in claim 1, further including said menu page having an anonymous selection item that enables said initiator to indicate whether the identification of said recipient is to be revealed or made anonymous, and said conversation server is configured to receive said selection item indicated to reveal or not reveal the identification of said recipient

5. The system as recited in claim 4, further including said anonymous selection item is encrypted by said encryption/decryption engine.

6. The system as recited in claim 2, further including said menu page having an anonymous selection item that enables said initiator to indicate whether the identification of said recipient is to be revealed or made anonymous, and said conversation server is configured to receive said selection item indicated to reveal or not reveal the identification of said recipient

7. The system as recited in claim 3, further including said menu page having an anonymous selection item that enables said initiator to indicate whether the identification of said recipient is to be revealed or made anonymous, and said conversation server is configured to receive said selection item indicated to reveal or not reveal the identification of said recipient.

8. The system as recited in claim 7, further including said anonymous selection item is encrypted by said encryption/decryption engine.

9. The system as recited in claim 1, further including said menu page having a ‘Reveal Domains of Participants’ selection item that enables said initiator to indicate whether a domain level said recipient's email address will be revealed or disclosed to all of the recipients, and said conversation server is configured to receive said selection item indicated to reveal or not reveal the domain level of recipient's email.

10. The system as recited in claim 3, further including said menu page having a ‘Reveal Domains of Participants’ selection item that enables said initiator to indicate whether a domain level said recipient's email address will be revealed or disclosed to all of the recipients, and said conversation server is configured to receive said selection item indicated to reveal or not reveal the domain level of recipient's email.

11. The system as recited in claim 1, further including said menu page including having a Reveal Participants in text message selection item that enables said indicator to indicate an email address associated with said recipient is to be revealed to the other recipients, and said conversation server is configured to receive said selection item to transmit a telephone number, email address, or social network identifier associated with said recipient is to be revealed to the other recipients

12. The system as recited in claim 2, further including said menu page including having a Reveal Participants in text message selection item that enables said indicator to indicate a telephone number, an email address, or a social network identifier associated with said recipient is to be revealed to the other recipients, and said conversation server is configured to receive said selection item to transmit said telephone number, said email address or said social network identifier associated with said recipient is to be revealed to the other recipients

13. The system as recited in claim 5, further including said menu page including having a Reveal Participants in text message selection item that enables said indicator to indicate a telephone number, an email address, or a social network identifier associated with said recipient is to be revealed to the other recipients, and said conversation server is configured to receive said selection item to transmit said telephone number, said email address, or said social network identifier associated with said recipient is to be revealed to the other recipients.

14. The system as recited in claim 3, further including said menu page including having a Reveal Participants in text message selection item that enables said indicator to indicate a telephone number, an email address, or a social network associated with said recipient is to be revealed to the other recipients, and said conversation server is configured to receive said selection item to transmit said telephone number, said email address or said social network identifier associated with said recipient is to be revealed to the other recipients

15. A method of communication over a digital communication network in which either the initiator of the communication or at least one recipient of the communication is anonymous comprising the following steps:
a. connecting a conversation server to said digital communication network configured to receive text messages and transmit text messages between an initiator and a recipient, said conversation server configured to encrypt the initiator's network identification and insert the initiator's encrypted network identification into said text message and forward text message and said initiator's encrypted network identification to a designed recipient, said conversation server also configured to receive a reply from said recipient containing the encrypted initiator's network identity, said conversation server decrypts said initiator's network identity and routes said reply message to said initiator;
b. initiating a digital network communication by an initiator with at least one designated recipient, said initiator and said recipient each being assigned a unique network identification
c. creating a text message;
d. transmitting said text message, said initiator identification, and said recipient's network identification to said conversation server;
e. encrypting said initiators' network identification and a timestamp into said text message;
f. transmitting said text message and encrypted initiator's network identification and timestamp to said recipient; and,
g. receiving a reply containing said encrypted initiator's network identification and timestamp from said recipient and decrypting said initiator's network identification and said timestamp and routing said reply message to said initiator.

16. A method as recited in claim 15, wherein said conversation server includes an encryption/decryption engine configured to combine a timestamp with said initiator's identification code to generate a unique encryption key that is embedded into said message.

17. A method as recited in claim 15, wherein said initiator also indicates if a reply from said recipient will include recipient identification information which is embedded in said text message from said initiator and that conversation server is configured to transmit or not transmit the recipient identification based on said recipient identification information submitted by said initiator.
